(19) United States
(12) Patent Application Publication
(10) Pub. No.: US 2026/0368227 A1
(43) Pub. Date: Nov. 19, 2026

(54) CORRELATING USER HISTORY WITH WEBSITE USAGE PATTERNS TO ENHANCE GENERATIVE ARTIFICIAL INTELLIGENCE USER EXPERIENCE

(71) Applicant: Dell Products L.P., Round Rock, TX (US)

(72) Inventors: Ming Qian, Newton, MA (US); Corinne Schulze, Hopkinton, MA (US); Michael Barnes, Doylestown, PA (US); Ashutosh P. Nanekar, Cary, NC (US); Edward Henry, Jurupa Valley, CA (US)

(21) Appl. No.: 18/747,141

(22) Filed: Jun. 18, 2024

(51) Int. Cl. G06F 16/334; G06F 11/34; G06F 16/3329

(52) U.S. Cl. CPC G06F 16/3347; G06F 11/3438; G06F 16/3329

(57) ABSTRACT

The technology described herein is directed towards using website usage patterns learned during a user journey, such as corresponding to user clickthrough data to obtain recommended questions/queries for submitting to a generative artificial intelligence tool. Data related to a user's clickthrough event(s) are transferred into clickthrough vector embeddings; the embeddings can be clustered together to identify patterns. These patterns are correlated with user queries having similar patterns; a sufficiently close similar pattern is used to present suggested topics or queries to the user. A manually entered user-generated query is used with a sentence embeddings generator to obtain a sentence embedding for that query, aligned with the clickthrough vector embeddings. The recommended query or user-generated query is submitted to a generative artificial intelligence tool to obtain an answer. In this way, for example, a user can troubleshoot an issue even without knowing appropriate query terms in advance.

### BACKGROUND

Generative artificial intelligence (AI) tools such as retrieval-augmented generation (RAG) systems with large language models (LLMs) can only provide responses to questions/queries. Consequently, to obtain a meaningful result, a user needs to be somewhat well-versed and educated in the subject matter of the query to ensure the response returns relevant information. In other words, if a user's query does not contain appropriate terms, the response likely will not include the appropriate information.

### BRIEF DESCRIPTION OF THE DRAWINGS

The technology described herein is illustrated by way of example and not limited in the accompanying figures in which like reference numerals indicate similar elements and in which:

FIG. 1 is a block diagram representation of an example system in which queries for a generative artificial intelligence (AI) system can be recommended to users based on user interactions with content, in accordance with various implementations and embodiments of the subject disclosure.

FIGS. 2 and 3 comprise a sequence/signaling diagram representation of example user flow and system backend flow, in accordance with various implementations and embodiments of the subject disclosure.

FIG. 4 is a block diagram and data flow representation of an example clickthrough-based recommendation engine including interrelated components coupled to a generative AI system, in accordance with various implementations and embodiments of the subject disclosure.

FIGS. 5 and 6 comprise a flow diagram showing example operations related to user interaction with a recommendation engine to obtain results from a generative AI system, in accordance with various implementations and embodiments of the subject disclosure.

FIG. 7 is a flow diagram showing example operations related to submitting a recommended query, based on clickthrough embedding vector data, to a generative AI system to obtain and return a response, in accordance with various implementations and embodiments of the subject disclosure.

FIG. 8 is a flow diagram showing example operations related to obtaining a recommended query based on clickthrough embedding vector data, and taking an action in response to determining whether to use the recommended query, in accordance with various implementations and embodiments of the subject disclosure.

FIG. 9 is a flow diagram showing example operations related to detecting user click interaction data directed towards a user journey, presenting a predicted query and predicted answer, and maintaining user information, topic information, interaction information, and feedback data related to the user journey, in accordance with various implementations and embodiments of the subject disclosure.

FIG. 10 is a block diagram representing an example computing environment into which the subject matter described herein may be incorporated and/or may communicate.

FIG. 11 depicts an example schematic block diagram of a computing environment with which the disclosed subject matter can interact/be implemented at least in part, in accordance with various implementations and embodiments of the subject disclosure.

### DETAILED DESCRIPTION

Various implementations and embodiments of the technology described herein are generally directed towards a generative artificial intelligence (AI) system that operates based on website usage patterns such as user clickthrough data to enhance the user experience by providing questions/queries derived from user history that are correlated to one or more user usage patterns. In one implementation, the user's clickthroughs are transferred into vector embeddings, and the embeddings are clustered together to identify patterns. These patterns are correlated with user queries having similar patterns, and then offered up to the user as suggested topics or queries, e.g., by a retrieval-augmented generation (RAG) system and large language model (LLM). The RAG (retrieval-augmented generation) system and LLMs can include any open source and/or proprietary models.

In general, the user journey through information content (e.g., in pages and other interfaces such as widgets) is used to understand the user intent and the user context, such as during troubleshooting, to enable much more efficient and effective troubleshooting. For example, when the system determines that the user is looking at an anomaly, the technology described herein is able to help the user troubleshoot the issue faster by interpreting the user's intent and offering related queries based on the user's and other prior users'patterns (clickthrough journeys of this individual user along with other peer users'journeys), plus past queries and relevant knowledge base articles, for example.

By way of example, for a cloud-based AIOps (artificial intelligence for information technology (IT) operations) proactive monitoring (and predictive analytics) application, such as DELL CLOUDIQ, taking the user journey through such a monitoring application allows the generative AI system to preemptively understand the kinds of troubleshooting that the user is doing as the user moves around the application. For example, this allows the generative AI system to open a conversation with intelligent insights into what the user is investigating, and proactively provide relevant information to the user.

Reference throughout this specification to “one embodiment,” “an embodiment,” “one implementation,” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. It also should be noted that terms used herein, such as “optimization,” “optimize” or “optimal” and the like (e.g., “maximize,” “minimize” and so on) only represent objectives to move towards a more optimal state, rather than necessarily obtaining ideal results.

The subject disclosure will now be described more fully hereinafter with reference to the accompanying drawings in which example components, graphs and/or operations are shown. In the following description, for purposes of explanation, numerous specific details are set forth in order to provide a thorough understanding of the various embodiments. However, the subject disclosure may be embodied in many different forms and should not be construed as limited to the examples set forth herein.

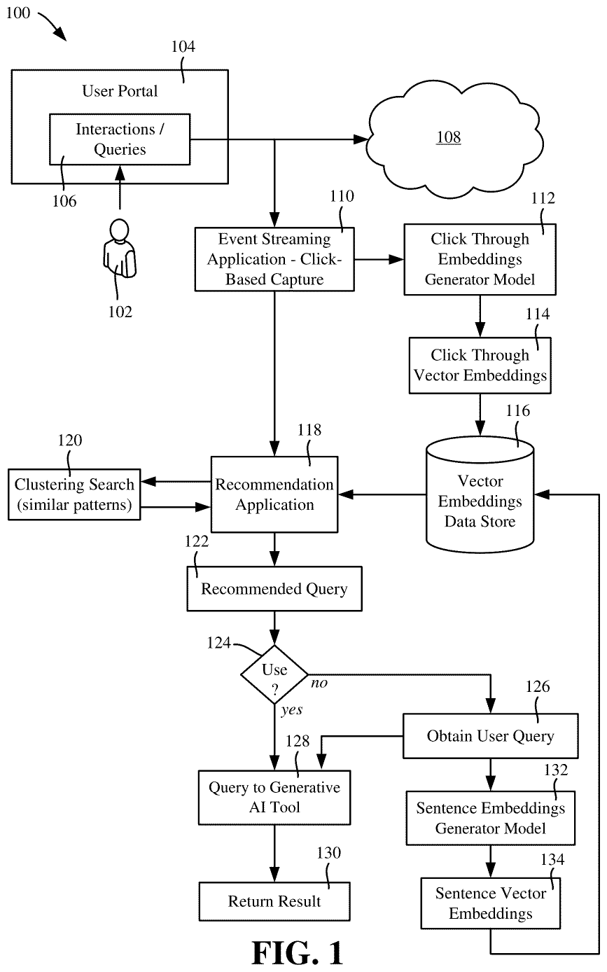

FIG. 1 shows an example system/architecture 100 by which a generative AI system can provide recommended queries and corresponding answers to a user 102 interacting with a program, such as via a portal 104. The user 102 can interact (block 106) via clicks and sentence-type queries with web pages (block 108) and other content. An event streaming application/platform 110, such as APACHE FLINK, can capture such click events. Based on such events/clickthrough data streams, a clickthrough embeddings generator model 112 such as Pattern2Vec or Transformer Encoder Model can be used to generate clickthrough vector embedding data 114 for website-related usage patterns, which are stored in a vector embeddings data store 116. The vector embeddings data store 116 can be a vector database (e.g., PGVECTOR OR DATASTAX vector search) to facilitate rapid data retrieval.

As described herein, a recommendation application 118 performs a clustering search 120 to match the user's clickthrough embedding vector data to other stored embedding vector data to look for a close match, to select a recommended query 122 (which can be an actual query or a topic) corresponding to the closest match for returning as output. Note that there may be more than one recommended query that matches closely, and it is feasible to provide a user with multiple recommended queries; notwithstanding, described herein for purposes of explanation is a single recommended query 122.

Decision block 124 represents a determination as to whether to use the recommended query 122. More particularly, as described herein with respect to one example implementation, only a recommended query that satisfies a closeness threshold (based on vector embeddings clustering closeness) will be presented to the user. If presented to the user, the user also can choose to reject the query. If the query is not used, the user inputs a user-generated query at block 126, e.g., a sentence-type query, such as in response to a prompt or the like.

Once a query is ready, whether it is the recommended query (if presented to the user and the user accepted the recommended query) or it is a user-generated query, the query is passed to a generative AI tool 128, such as ChatGPT or another, similar generative AI-enabled tool, and a result/answer returned (block 130). Note that for a user-generated query obtained via block 126, a sentence embeddings generator model 132 (such as Sentence Bert, Doc2Vec or InferSent) can be used to generate sentence vector embeddings 134 from the user-generated questions/queries submitted to the generative AI system, which are then maintained in the vector data store 116 in association with the clickthrough vector embedding data.

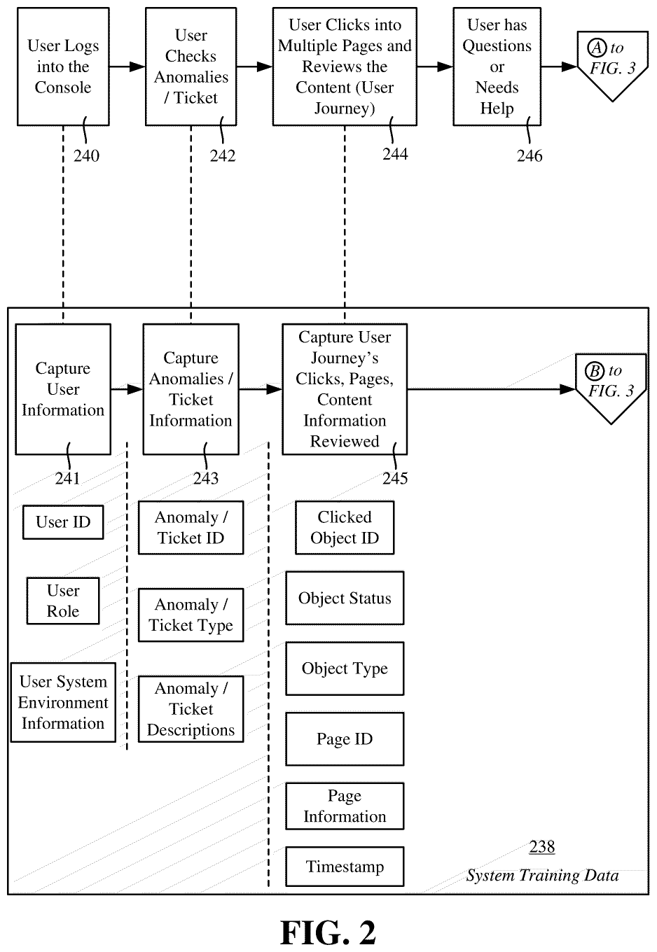

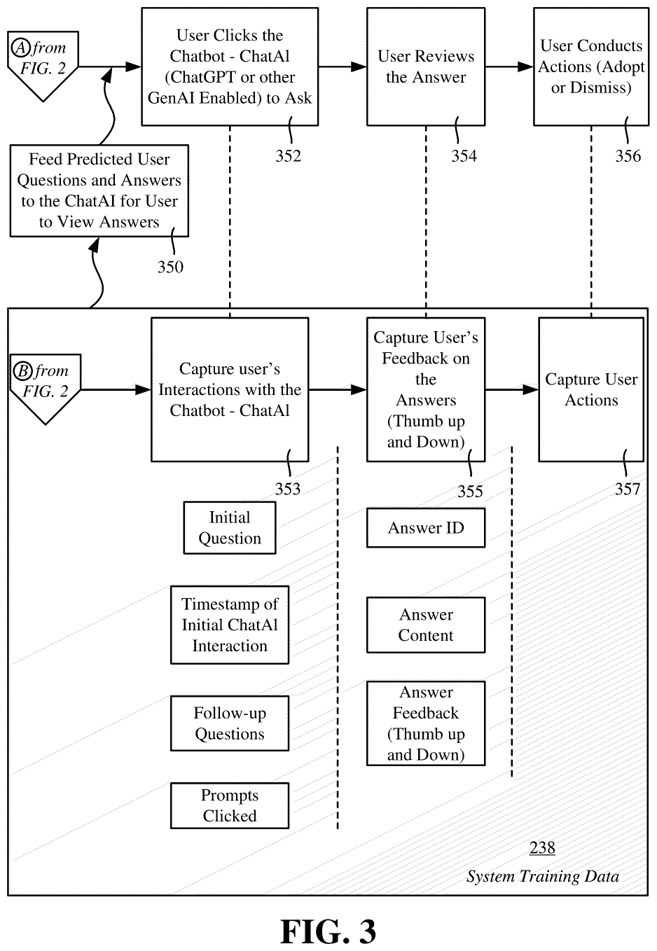

FIGS. 2 and 3 depict an example flow of information that can be captured and used to generate embeddings in the lower portion entitled “System Training Data” 238. FIGS. 2 and 3 also depict the user flow when the recommendation engine is employed to provide suggested queries to the generative AI system, beginning at block 240 of FIG. 2 where the 240 user logs into a console (e.g., coupled to the portal 104 of FIG. 1). Upon login, block 241 represents capturing user-related information, such as including, for example, but not limited to user ID, user role, and user system environment information.

Block 242 represents the user checking anomalies/ticket in this example. This information is captured (block 243), and for example can include, but is not limited to anomaly ticket ID, anomaly ticket type, and anomaly ticket descriptions.

At block 244, in this example, the user clicks into multiple pages and reviews their content (that is, has a user journey). Block 245 captures the user journey's data, such as click-related data (clicked object ID, object status, object type), page-related data (page ID, page information/content reviewed) and a timestamp, in this example.

Block 246 is representative of when a user has questions or needs help. The example information flow continues at FIG. 3.

Block 350 of FIG. 3 represents the system (e.g., a retrieval-augmented generation (RAG) system/large language models (LLM)) feeding predicted user questions and answers to the ChatAI for the user to view. These can be accompanied by explanatory text from the system, such as “it looks like you are troubleshooting an anomaly, here are the typical support questions and solutions that came from this kind of troubleshooting journey.”

At block 352, in this example the user clicks the chatbot—ChatAI (e.g., ChatGPT or other Generative AI-enabled tool) to ask one or more of the recommended questions. Block 353 captures the user's interactions with the chatbot—ChatAI, e.g., the initial question, timestamp of the initial ChatAI interaction, any follow-up questions, prompts clicked, and so on.

At block 354, the user reviews the answer. Block 355 captures any user feedback on the answers (e.g., thumb up or down per answer), that is, for each answer, feedback can include, but is not limited to, answer ID, answer content, and answer feedback (thumb up and down data).

At block 356, the user conducts one or more actions, e.g., the user adopts or dismisses the answer. Block 357 captures the user action(s).

To summarize thus far, the technology described herein provides a way to understand user intent through the collection of clickthrough data and recognizing patterns in clickthrough data, system data, and questions that are asked to a generative AI tool. This includes collecting user website usage patterns and subsequent questions/queries to the generative AI system, machine/deep learning models to generate embeddings representing both the usage patterns and the generative AI questions/queries, and additional machine learning models to retrieve usage patterns (e.g., k-nearest neighbor, or KNN) that represent the closest match to current behavior. To reiterate, in one implementation the closest match needs to meet a threshold, otherwise a recommendation cannot be made; e.g., there is not enough stored embedding data for this particular topic to provide a good usage pattern match.

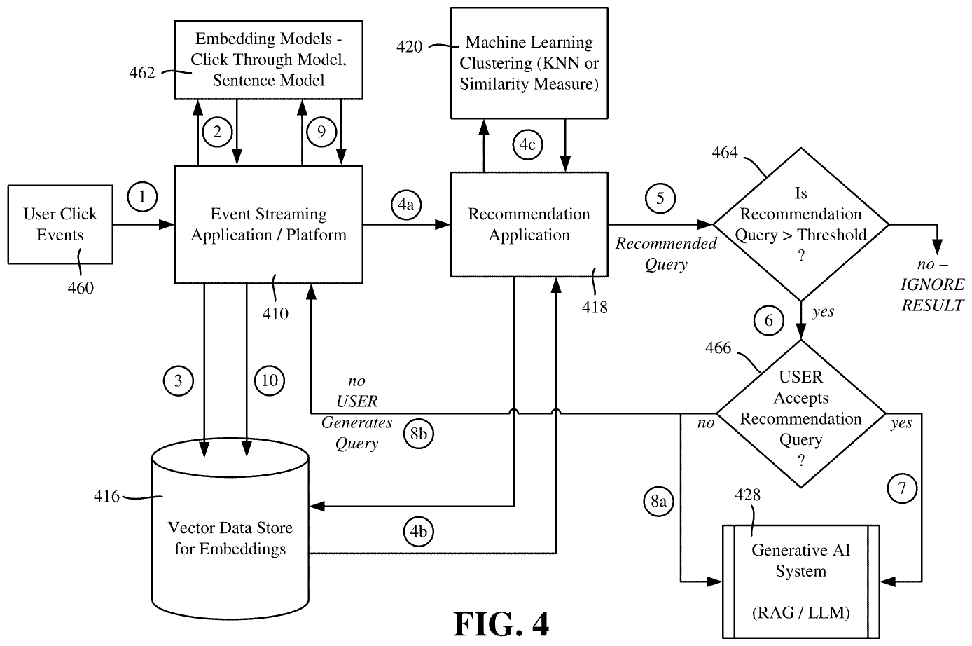

An example outline of a recommendation engine and its usage is represented in FIG. 4, in which user click events 460 (e.g., via a portal) are captured by an event streaming application/platform 410, shown by arrow (1) in which a captured click event is obtained by the event streaming platform 410.

At the arrows labeled (2), after a series of clickthrough events or another trigger, the event streaming application/platform 410 calls a deep learning prediction service 462 to generate/update the user clickthrough embeddings based on these captured event(s). In general, the deep learning prediction service 462 corresponds to the clickthrough embeddings generator model 112 and sentence embeddings generator model 132 of FIG. 1.

At arrow (3), after the clickthrough embeddings are generated, the vector embeddings are saved to a vector data store 416, e.g., as {key: value}={user id: user embedding vector}. As represented by arrow (4a), a recommendation application 418 takes the clickthrough sequence ID, (when a user is browsing a website), calls the vector data store 416 to get the clickthrough embedding vector (arrows (4b)), and then calls (arrows (4c)) a machine learning clustering model 420, e.g., a KNN service to perform a KNN search. The result is one or more recommended queries provided from the recommendation application (arrow (5)).

At arrow (6), the recommended query is passed to the user if the corresponding vector of the recommended query meets one or more threshold (closeness/similarity) criterion as evaluated at decision block 464 (e.g., KNN Euclidean distance, Manhattan distance, Minkowski distance, Hamming distance, cosine distance/similarity) and so on. Otherwise, the result is ignored, and the user is provided with a way to manually enter a query. If instead at arrow (7) the user accepts the suggested query (decision block 466), the query is passed to the generative AI system 428 and an appropriate response is returned.

If the user rejects the suggested query (or if no suggested query is available), then the user generates a query, which is passed to both the generative AI System 428 (arrow (8a)) and the event streaming application/platform 410 (arrow (8b)). At arrow (9), the event streaming application/platform 410 passes the query (sentence(s)) to the sentence embedding model in the embedding models 462 to obtain sentence embedding vector data. As represented by arrow (10), the query sentence embeddings are stored in the vector data store 416 with an appropriate key that aligns the sentence embeddings with the clickthrough embeddings. In this way, the query can be passed through the machine learning clustering service when another user goes through a similar pattern in the future.

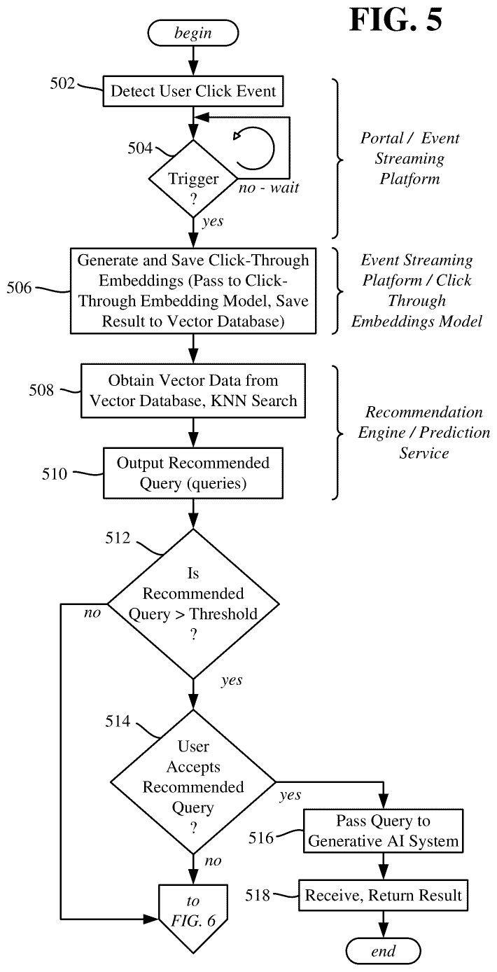

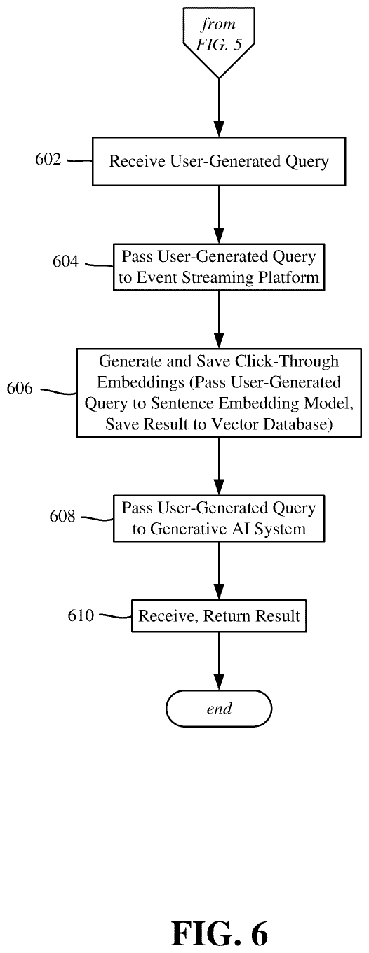

FIGS. 5 and 6 are a flow diagram showing example operations related to obtaining recommended queries based on user interactions with content, beginning at operations 502 and 504, which can be performed in the portal or in an application coupled thereto, and/or in part in the event streaming platform. Operation 502 represents detecting a user click event, and operation 504 represents waiting for a triggering action. A single click event can serve as the trigger, by considering the time the user has spent interacting with a particular screen/widget, any clicks (or scrolling) within the screen/widget, and/or the context around information surfaced in the screen/widget, such as issue severity, planning insight, and the like. Alternatively, or in addition to the above considerations, a series of click events can serve as the trigger.

At operation 506, the event streaming platform, in conjunction with the clickthrough embeddings model, generates the clickthrough embeddings. The resultant clickthrough embeddings are saved to the vector data store.

In general, operations 508 and 510 are performed by the recommendation engine/prediction service, including operation 508 to obtain vector data from the vector database, and initiate the KNN search. Operation 510 outputs the recommended query (or queries).

Operation 512 represents determining whether the recommended query satisfies the threshold (the user's clickthrough embedding data are sufficiently close to a set of stored embedding data representative of a recommended query). If not, the example process continues at operation 602 of FIG. 6.

If the recommended query satisfies the threshold, operation 514 represents the user determining whether or not to accept the recommended query. If accepted, operation 516 passes the recommended query to the generative AI system, and operation 518 returns the result. If instead the user decides to not use the recommended query, the example process continues at operation 602 of FIG. 6.

Operation 602 represents receiving a user-generated query, which operation 604 passes to the event streaming platform, and in turn to the sentence embedding model. Operation 606 represents the sentence embedding model generating sentence embeddings, which the event streaming platform saves to the vector data store. Further, operation 608 represents passing the user-generated query to the generative AI system, with operation 610 returning the result.

By way of some examples of use cases, consider a use case related to a storage device/storage system capacity anomaly, in which a customer receives an alert on a system that is hitting a capacity threshold. The user goes into the system to see that there was a spike on the capacity chart. In this example, consider that it was a brief spike with a known similar pattern; the user is thus looking at an anomaly. The actions the user takes after this informs the generative AI system if the user is concerned about this spike or not. For example, if the user starts to look into the hosts on the system to see what might have affected the capacity spike, and then launches the generative AI system described herein, the AI can use this data to provide suggested queries to the generative AI system, and thereby provide relevant feedback to the user about the spike in capacity.

Another example use case is directed towards an update alert, such as when customer receives an alert on a system that has been determined by the enterprise vendor or the like to need an update. The user goes to an “updates” page, spends time browsing the details of the updates, and proceeds to download the update. The user may be confused about what to do from there to execute the update, and thus launches the generative AI system described herein. The system has detected the download and recognized (analyzed) that the user had spent a longer time on the download update page, whereby the generative AI system opens with a suggestion of how to install the update on that system.

Yet another example use case is directed towards threshold creation, such when a customer receives many alerts on a system (e.g., a storage system) regarding a few potential issues that the customer realizes are not problems. The customer user navigates to the system and then to the administrator section, and looks at various pages in the administrator section. With each page and widget, for example, the user spends different amounts of time reviewing, and then launches the generative chat system as described herein. Because the generative chat system knows that the user began this journey looking at the alerts, and has followed the journey to the administrator section and the various pages, the system has an understanding of which information the user seems to care about more, in order to understand the user intent and context fully. Thus, the system provides a suggested start to the session, e.g., “Looks like you are trying to change your capacity threshold on this system, would you like help?”

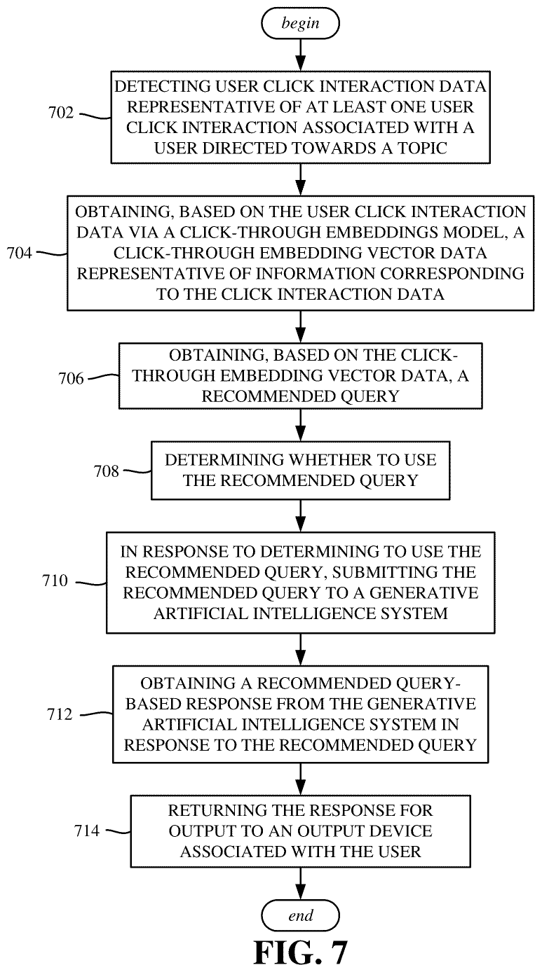

One or more implementations and embodiments can be embodied in a system, such as represented in the example operations of FIG. 7, and for example can include a memory that stores computer executable components and/or operations, and at least one processor that executes computer executable components and/or operations stored in the memory. Example operations can include operation 702, which represents detecting user click interaction data representative of at least one user click interaction associated with a user directed towards a topic. Example operation 704 represents obtaining, based on the user click interaction data via a clickthrough embeddings model, a clickthrough embedding vector data representative of information corresponding to the click interaction data. Example operation 706 represents obtaining, based on the clickthrough embedding vector data, a recommended query. Example operation 708 represents determining whether to use the recommended query. Example operation 710 represents, in response to determining to use the recommended query, submitting the recommended query to a generative artificial intelligence system. Example operation 712 represents obtaining a recommended query-based response from the generative artificial intelligence system in response to the recommended query. Example operation 714 represents returning the response for output to an output device associated with the user.

The topic can include troubleshooting a topic-related alert.

The topic can include at least one of: a storage system anomaly, a storage system update, or a storage system threshold modification operation.

Further operations can include maintaining the clickthrough embedding vector data in a vector embeddings data store.

Determining whether to use the recommended query can include obtaining user input indicative of acceptance of the recommended query by the user.

The clickthrough embedding vector data can include first embedding vector data, and determining whether to use the recommended query can include evaluating second vector embedding data representative of the recommended query in comparison to the first vector embedding data to determine whether the first vector embedding data and the second vector embedding data satisfy at least one similarity threshold criterion. The at least one similarity threshold criterion can be based on at least one of: a Euclidean distance between first data of the first vector embedding data and second data of the second vector embedding data, a Manhattan distance between the first data and the second data, a Minkowski distance between the first data and the second data, a Hamming distance between the first data and the second data, or a cosine distance between the first data and the second data.

Obtaining the recommended query can include searching a vector embeddings data store based on a nearest neighbor search using the clickthrough embedding vector data.

Further operations can include, in response to determining not to use the recommended query: obtaining a user-generated query, submitting the user-generated query to the generative artificial intelligence system, obtaining a user-generated-based query response from the generative artificial intelligence system in response to the user-generated query, and returning the user-generated-based query response for output to the output device.

Further operations can include obtaining, based on the user-generated-based query, via a sentence embeddings model, sentence embedding vector data representative of the user-generated query, and maintaining the sentence embedding vector data in a vector embeddings data store.

Further operations can include, prior to the obtaining of the clickthrough embedding vector data, determining whether to trigger the obtaining of the clickthrough embedding vector data based on at least one of: a series of two or more clickthrough events associated with the user, or at least one triggering criterion. The at least one triggering criterion can include at least one of: an amount of user interaction time with an interface, a number of clicks within the interface, or context data associated with topic-related information presented in the interface corresponding to the topic.

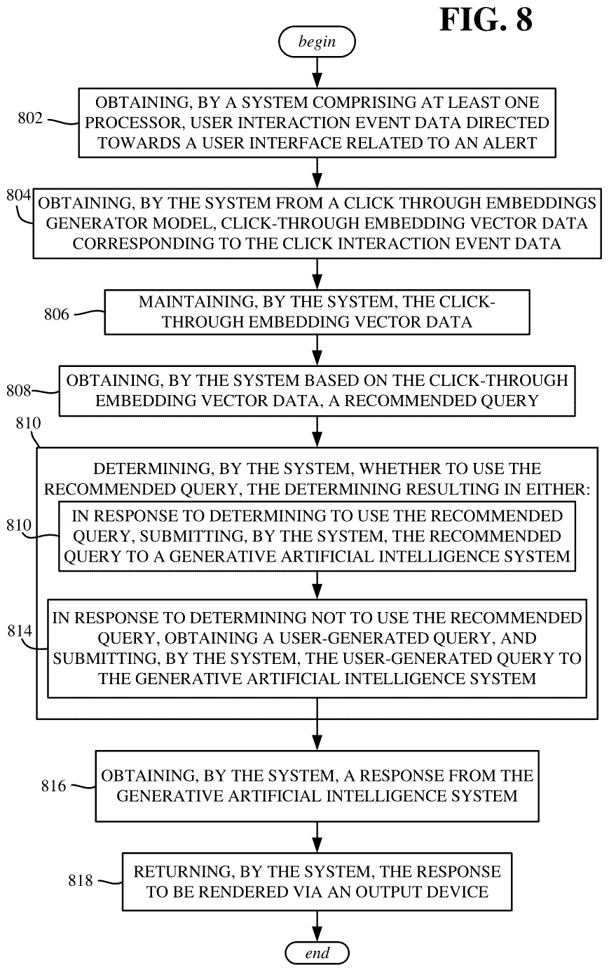

One or more example implementations and embodiments, such as corresponding to example operations of a method, are represented in FIG. 8. Example operation 802 represents obtaining, by a system including at least one processor, user interaction event data directed towards a user interface related to an alert. Example operation 804 represents obtaining, by the system from a clickthrough embeddings generator model, clickthrough embedding vector data corresponding to the click interaction event data. Example operation 806 represents maintaining, by the system, the clickthrough embedding vector data. Example operation 808 represents obtaining, by the system based on the clickthrough embedding vector data, a recommended query. Example operation 810 represents determining, by the system, whether to use the recommended query, the determining resulting in either: in response to determining to use the recommended query, submitting, by the system, the recommended query to a generative artificial intelligence system (example operation 812), or in response to determining not to use the recommended query, obtaining a user-generated query, and submitting, by the system, the user-generated query to the generative artificial intelligence system (example operation 814). Example operation 816 represents obtaining, by the system, a response from the generative artificial intelligence system. Example operation 818 represents returning, by the system, the response to be rendered via an output device.

Further operations can include, in response to determining not to use the recommended query, obtaining, by the system from a sentence embeddings model based on the user-generated query, sentence embedding vector data representative of the user-generated query, and maintaining the sentence embedding vector data in a vector embeddings data store.

The clickthrough embedding vector data can include first embedding vector data, and determining whether to use the recommended query can include evaluating second vector embedding data representative of the recommended query in comparison to the first vector embedding data to determine whether the first vector embedding data and the second vector embedding data satisfy one or more similarity threshold criteria.

The recommended query can be located via a result of a nearest neighbor search of vector embeddings, and determining whether to use the recommended query can include determining whether the clickthrough embedding data is threshold close to the result according to a closeness threshold.

Determining whether to use the recommended query can include obtaining user input indicative of user acceptance of the recommended query.

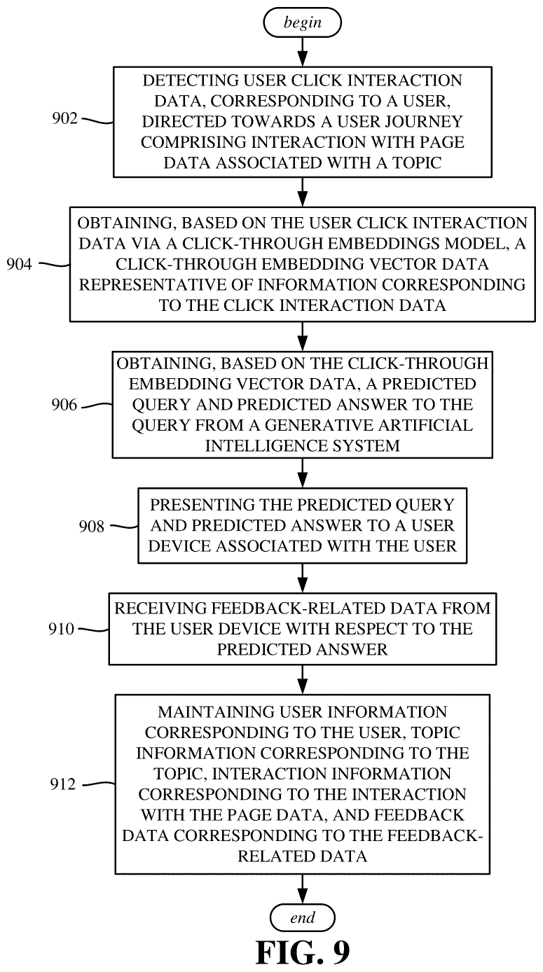

FIG. 9 summarizes various example operations, e.g., corresponding to a machine-readable medium, including executable instructions that, when executed by a processor, that, when executed by at least one processor, facilitate performance of operations. Example operation 902 represents detecting user click interaction data, corresponding to a user, directed towards a user journey comprising interaction with page data associated with a topic. Example operation 904 represents obtaining, based on the user click interaction data via a clickthrough embeddings model, a clickthrough embedding vector data representative of information corresponding to the click interaction data. Example operation 906 represents obtaining, based on the clickthrough embedding vector data, a predicted query and predicted answer to the query from a generative artificial intelligence system. Example operation 908 represents presenting the predicted query and predicted answer to a user device associated with the user. Example operation 910 represents receiving feedback-related data from the user device with respect to the predicted answer. Example operation 912 represents maintaining user information corresponding to the user, topic information corresponding to the topic, interaction information corresponding to the interaction with the page data, and feedback data corresponding to the feedback-related data.

Further operations can include obtaining user question input data related to at least one of the predicted query or the predicted answer, and maintaining question information corresponding to the question input data.

The user can dismiss the predicted query and predicted answer, and further operations can include obtaining a user-generated query from the user, and submitting the user-generated query to the generative artificial intelligence system.

As can be seen, the technology described herein uses multimodal web usage data to generate query recommendations, via machine learning and a recommendation application, which align with user intent. Because a user journey can involve several screens and widgets before the user lands on the GenAI query screen, the system is able to consider various considerations to generate appropriate recommended queries, such as including, but not limited to, the time the user has spent on a particular screen/widget, any clicks within the screen/widget, and the context around information surfaced in the screen/widget, such as issue severity, planning insight, and the like. The technology described herein thus enables relevant information to be provided to a user even when the user lacks the subject matter expertise to provide appropriate queries to a generative AI system.

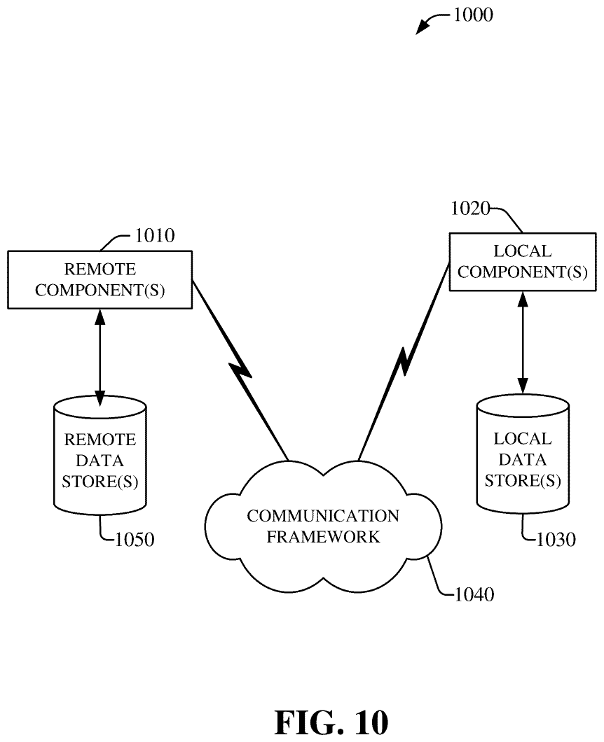

FIG. 10 is a schematic block diagram of a computing environment 1000 with which the disclosed subject matter can interact. The system 1000 can include one or more remote component(s) 1010. The remote component(s) 1010 can be hardware and/or software (e.g., threads, processes, computing devices). In some embodiments, remote component(s) 1010 can be a distributed computer system, connected to a local automatic scaling component and/or programs that use the resources of a distributed computer system, via communication framework 1040. Communication framework 1040 can comprise wired network devices, wireless network devices, mobile devices, wearable devices, radio access network devices, gateway devices, femtocell devices, servers, etc.

The system 1000 also comprises one or more local component(s) 1020. The local component(s) 1020 can be hardware and/or software (e.g., threads, processes, computing devices). In some embodiments, local component(s) 1020 can comprise an automatic scaling component and/or programs that communicate/use the remote resources 1010, etc., connected to a remotely located distributed computing system via communication framework 1040.

One possible communication between a remote component(s) 1010 and a local component(s) 1020 can be in the form of a data packet adapted to be transmitted between two or more computer processes. Another possible communication between a remote component(s) 1010 and a local component(s) 1020 can be in the form of circuit-switched data adapted to be transmitted between two or more computer processes in radio time slots. The system 1000 comprises a communication framework 1040 that can be employed to facilitate communications between the remote component(s) 1010 and the local component(s) 1020, and can comprise an air interface, e.g., Uu interface of a UMTS network, via a long-term evolution (LTE) network, etc. Remote component(s) 1010 can be operably connected to one or more remote data store(s) 1050, such as a hard drive, solid state drive, SIM card, device memory, etc., that can be employed to store information on the remote component(s) 1010 side of communication framework 1040. Similarly, local component(s) 1020 can be operably connected to one or more local data store(s) 1030, that can be employed to store information on the local component(s) 1020 side of communication framework 1040.

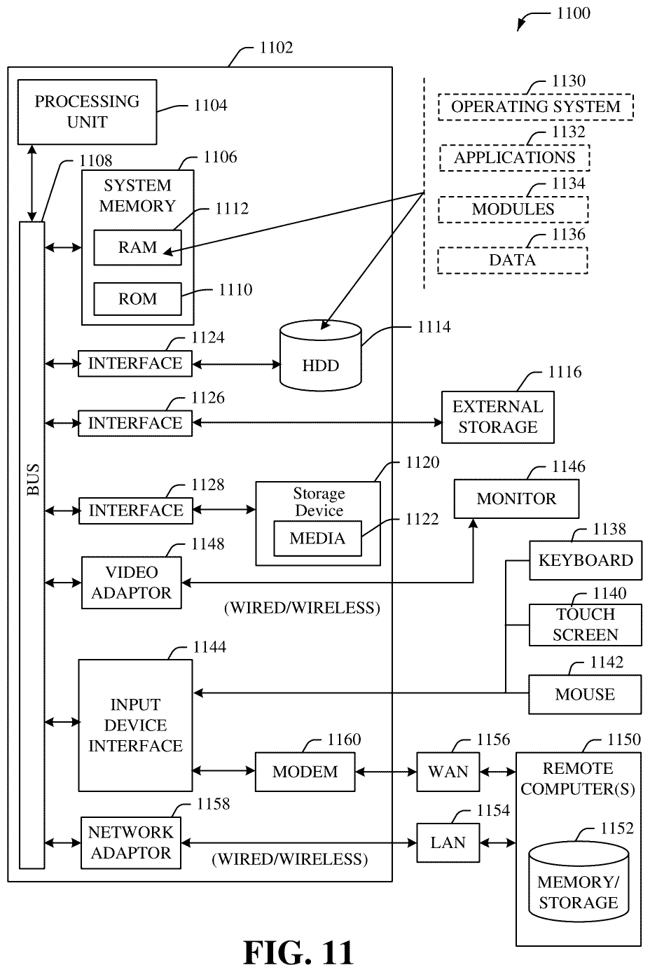

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various implementations and embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), and can include one or more external storage devices 1116 (e.g., a magnetic floppy disk drive (FDD) 1116, a memory stick or flash drive reader, a memory card reader, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114.

Other internal or external storage can include at least one other storage device 1120 with storage media 1122 (e.g., a solid state storage device, a nonvolatile memory device, and/or an optical disk drive that can read or write from removable media such as a CD-ROM disc, a DVD, a BD, etc.). The external storage 1116 can be facilitated by a network virtual machine. The HDD 1114, external storage device(s) 1116 and storage device (e.g., drive) 1120 can be connected to the system bus 1108 by an HDD interface 1124, an external storage interface 1126 and a drive interface 1128, respectively.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the . NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1194 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
at least one processor; and
at least one memory that stores executable instructions that, when executed by the at least one processor, facilitate performance of operations, the operations comprising:
detecting user click interaction data representative of at least one user click interaction associated with a user directed towards a topic;
obtaining, based on the user click interaction data via a clickthrough embeddings model, a clickthrough embedding vector data representative of information corresponding to the click interaction data;
obtaining, based on the clickthrough embedding vector data, a recommended query;
determining whether to use the recommended query;
in response to determining to use the recommended query, submitting the recommended query to a generative artificial intelligence system;
obtaining a recommended query-based response from the generative artificial intelligence system in response to the recommended query; and
returning the response for output to an output device associated with the user.

2. The system of claim 1, wherein the topic comprises troubleshooting a topic-related alert.

3. The system of claim 1, wherein the topic comprises at least one of: a storage system anomaly, a storage system update, or a storage system threshold modification operation.

4. The system of claim 1, wherein the operations further comprise maintaining the clickthrough embedding vector data in a vector embeddings data store.

5. The system of claim 1, wherein the determining of whether to use the recommended query comprises obtaining user input indicative of acceptance of the recommended query by the user.

6. The system of claim 1, wherein the clickthrough embedding vector data comprises first embedding vector data, and wherein the determining of whether to use the recommended query comprises evaluating second vector embedding data representative of the recommended query in comparison to the first vector embedding data to determine whether the first vector embedding data and the second vector embedding data satisfy at least one similarity threshold criterion.

7. The system of claim 6, wherein the at least one similarity threshold criterion is based on at least one of: a Euclidean distance between first data of the first vector embedding data and second data of the second vector embedding data, a Manhattan distance between the first data and the second data, a Minkowski distance between the first data and the second data, a Hamming distance between the first data and the second data, or a cosine distance between the first data and the second data.

8. The system of claim 1, wherein the obtaining of the recommended query comprises searching a vector embeddings data store based on a nearest neighbor search using the clickthrough embedding vector data.

9. The system of claim 1, wherein the operations further comprise, in response to determining not to use the recommended query:
obtaining a user-generated query;
submitting the user-generated query to the generative artificial intelligence system;
obtaining a user-generated-based query response from the generative artificial intelligence system in response to the user-generated query; and
returning the user-generated-based query response for output to the output device.

10. The system of claim 9, wherein the operations further comprise obtaining, based on the user-generated-based query, via a sentence embeddings model, sentence embedding vector data representative of the user-generated query, and maintaining the sentence embedding vector data in a vector embeddings data store.

11. The system of claim 1, wherein the operations further comprise, prior to the obtaining of the clickthrough embedding vector data, determining whether to trigger the obtaining of the clickthrough embedding vector data based on at least one of: a series of two or more clickthrough events associated with the user, or at least one triggering criterion.

12. The system of claim 11, wherein the at least one triggering criterion comprises at least one of: an amount of user interaction time with an interface, a number of clicks within the interface, or context data associated with topic-related information presented in the interface corresponding to the topic.

13. A method, comprising:
obtaining, by a system comprising at least one processor, user interaction event data directed towards a user interface related to an alert;
obtaining, by the system from a clickthrough embeddings generator model, clickthrough embedding vector data corresponding to the click interaction event data;
maintaining, by the system, the clickthrough embedding vector data;
obtaining, by the system based on the clickthrough embedding vector data, a recommended query;
determining, by the system, whether to use the recommended query, the determining resulting in either:
in response to determining to use the recommended query, submitting, by the system, the recommended query to a generative artificial intelligence system, or
in response to determining not to use the recommended query, obtaining a user-generated query, and submitting, by the system, the user-generated query to the generative artificial intelligence system;
obtaining, by the system, a response from the generative artificial intelligence system; and
returning, by the system, the response to be rendered via an output device.

14. The method of claim 13, further comprising, in further response to determining not to use the recommended query, obtaining, by the system from a sentence embeddings model based on the user-generated query, sentence embedding vector data representative of the user-generated query, and maintaining the sentence embedding vector data in a vector embeddings data store.

15. The method of claim 13, wherein the clickthrough embedding vector data comprises first embedding vector data, and wherein the determining of whether to use the recommended query comprises evaluating second vector embedding data representative of the recommended query in comparison to the first vector embedding data to determine whether the first vector embedding data and the second vector embedding data satisfy one or more similarity threshold criteria.

16. The method of claim 13, wherein the recommended query is located via a result of a nearest neighbor search of vector embeddings, and wherein the determining of whether to use the recommended query comprises determining whether the clickthrough embedding data is threshold close to the result according to a closeness threshold.

17. The method of claim 13, wherein the determining of whether to use the recommended query comprises obtaining user input indicative of user acceptance of the recommended query.

18. A non-transitory machine-readable medium, comprising executable instructions that, when executed by at least one processor, facilitate performance of operations, the operations comprising:
detecting user click interaction data, corresponding to a user, directed towards a user journey comprising interaction with page data associated with a topic;
obtaining, based on the user click interaction data via a clickthrough embeddings model, a clickthrough embedding vector data representative of information corresponding to the click interaction data;
obtaining, based on the clickthrough embedding vector data, a predicted query and predicted answer to the query from a generative artificial intelligence system;
presenting the predicted query and predicted answer to a user device associated with the user;
receiving feedback-related data from the user device with respect to the predicted answer; and
maintaining user information corresponding to the user, topic information corresponding to the topic, interaction information corresponding to the interaction with the page data, and feedback data corresponding to the feedback-related data.

19. The non-transitory machine-readable medium of claim 18, wherein the operations further comprise obtaining user question input data related to at least one of the predicted query or the predicted answer, and maintaining question information corresponding to the question input data.

20. The non-transitory machine-readable medium of claim 18, wherein the user dismisses the predicted query and predicted answer, and wherein the operations further comprise obtaining a user-generated query from the user, and submitting the user-generated query to the generative artificial intelligence system.
